(19) United States
(12) Patent Application Publication
(10) Pub. No.: US 2022/0366533 A1
(43) Pub. Date: Nov. 17, 2022

(54) GENERATING HIGH RESOLUTION FIRE DISTRIBUTION MAPS USING GENERATIVE ADVERSARIAL NETWORKS

(71) Applicant: X Development LLC, Mountain View, CA (US)

(72) Inventors: Eliot Julien Cowan, Redwood City, CA (US); David Andre, San Francisco, CA (US); Benjamin Goddard Mullet, Sierraville, CA (US)

(21) Appl. No.: 17/322,562

(22) Filed: May 17, 2021

(51) Int. Cl. G06T 3/40; G06T 7/90; G06T 7/194

(52) U.S. Cl. CPC G06T 3/4046; G06T 3/4076; G06T 7/90; G06T 7/194; G06T 2207/10032

(57) ABSTRACT

Methods, systems, and apparatus, including computer programs encoded on computer storage media, for generating high-resolution fire distribution maps. In some implementations, a computer-implemented system obtains a low-resolution distribution map indicating fire distribution of an area with fire burning and a reference map indicating features of the same area. The system processes the low-resolution distribution map and the reference map using a generator neural network to generate output data including a high-resolution synthesized distribution map indicating fire distribution of the area. The generator neural network is trained, based on a plurality of training examples, with a discriminator neural network that outputs a prediction of whether an input to the discriminator neural network is a real distribution map or a synthesized distribution map.

### BACKGROUND

Wildfires have become increasingly problematic, as land development has continued to encroach into the wildland-urban interface, and as climate change has resulted in extended periods of drought. High quality machine learning models are very useful for predicting the spreading behavior of ongoing wildfires. The training, testing, and refinement of these machine learning models require accurate training data with high spatial and temporal resolution of actual real-world wildfires.

### SUMMARY

Machine learning models can be used in a variety of applications related to fire analysis, such as predicting the spreading behavior of wildfire, determining fire damages to natural resources and manmade structures, and facilitating law enforcement investigations for the starting location of a fire. Large-scale and high-resolution data sets of fire distribution and progression are needed for training and testing these machine learning models. However, observational datasets of wildfires with high spatial resolution are not commonly available, and when they are available, the datasets are usually collected infrequently and thus cannot capture the temporal evolving features of a fire. This poses a challenge for training and testing machine learning models for fire analysis.

This specification describes systems, methods, devices, and other techniques relating to automatically generating fire distribution data with high spatial resolutions based on available low-resolution fire-related data and pre-fire/post-fire geospatial data of the corresponding area.

In one aspect of the specification, a method is provided for generating high-resolution synthesized distribution maps indicating fire distribution of an area with fire burning. The method can be implemented by a computer system. The computer system obtains a low-resolution distribution map indicating fire distribution of the area with fire burning. The low-resolution distribution map has a first spatial resolution. The computer system also obtains a reference map that indicates features of the area. The reference map has a second spatial resolution that is higher than the first spatial resolution. The computer system then uses a machine learning model to process the low-resolution distribution map and the reference map to generate a high-resolution synthesized distribution map indicating the fire distribution of the area in a third spatial resolution that is higher than the first spatial resolution, and thus providing high-resolution fire distribution features needed for understanding the spreading behavior of wildfires.

The machine-learning model used for generating the high-resolution synthesized distribution map is a generative adversarial neural network (GAN) that includes a generator neural network and a discriminator neural network. In some implementations, the method further includes training the generator neural network together with the discriminator neural network based on a plurality of training samples. Each training example includes a low-resolution training distribution map having the first spatial resolution, a reference training map having the second spatial resolution, and a high-resolution training distribution map having the third spatial resolution. The training process includes repeatedly and alternatingly updating parameters of the discriminator neural network and the parameters of the generator neural network. After training, the generator neural network with the updated parameters then can be used for generating the high-resolution synthesized distribution map.

The described system utilizes GAN architecture to generate synthesized high-resolution fire distribution maps that resemble real high-resolution fire distribution maps in a feature space, while leveraging pre-fire and/or post-fire geophysical maps that provide information related to fire susceptibility in higher resolutions. As a result, the described system provides a means for creating previously unavailable high-quality datasets on fire spreading behaviors with both high spatial resolution and high temporal resolution based on available measurements of real-world fires. These datasets enable developing and evaluating models for understanding and predicting fire spreading behaviors.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example operating environment of a high-resolution fire-map generating system.

FIG. 2A is a block diagram illustrating an inference process to generate a high-resolution synthesized fire distribution map from low-resolution infrared data.

FIG. 2B is a block diagram illustrating a training process to learn model parameters of the machine learning model used in the high-resolution fire-map generating system.

FIG. 3 is a flow diagram of an example process of the high-resolution fire-map generating method.

FIG. 4 is a block diagram of an example computer system for implementing the high-resolution fire-map generating system.

Like reference numbers and designations in the various drawings indicate like elements.

### DETAILED DESCRIPTION

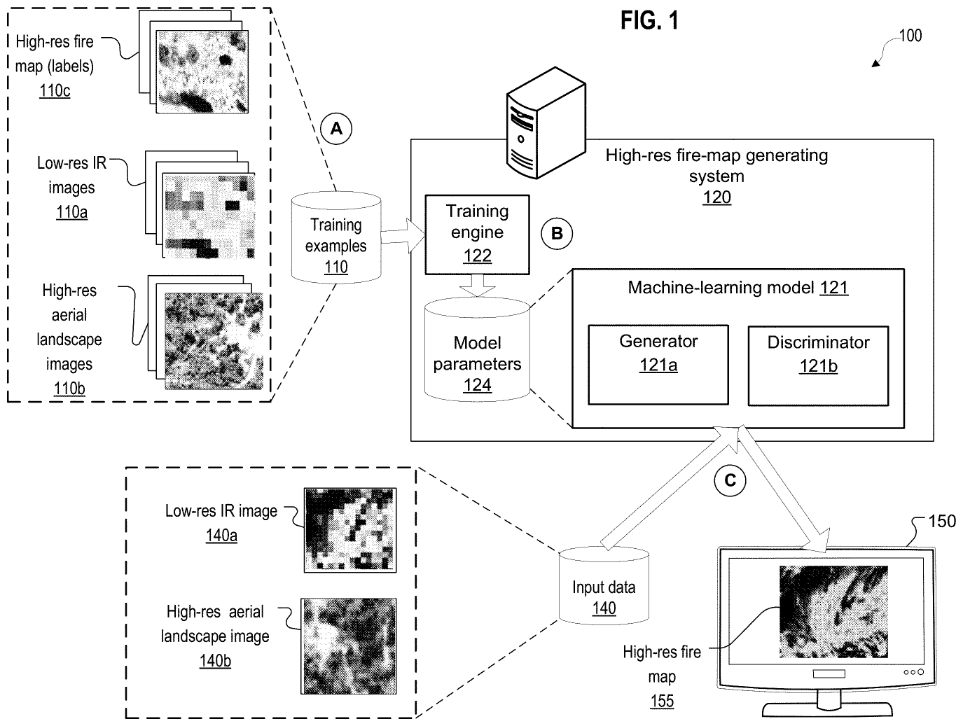

FIG. 1 is a block diagram showing an example of applying a high-resolution fire-map generating system 120 in an application scenario 100. Briefly, in order to build useful models of wildfire spread and wildfire behaviors, accurate, high-resolution training data of actual real-world fires is required. Unfortunately, the vast majority of observational datasets of wildfires available today have low resolution and/or are collected infrequently. For example, many satellite-based remote-sensing infrared (IR) imaging systems typically take survey infrared images with low resolutions, for example, with spatial resolution of around or lower than 400 m/pixel. The systems that provide higher-resolution survey images may only acquire the higher-resolution infrared image in every 12 hours, and sometimes in every two weeks. The low spatial and/or temporal resolutions in available datasets make it challenging to use them to understand and predict wild fire spread using data driven model-based prediction.

This specification describes a system and associated methods for automatically generating high-resolution fire distribution maps based on available fire-related data with low spatial resolutions and pre-fire/post-fire geophysical maps of the corresponding area. The fire-map generating system provided by this specification takes an input of a low-resolution distribution map indicating fire distribution of an area and a high-resolution reference map of the same area, and outputs a high-resolution synthesized distribution map indicating fire distribution of the area.

In FIG. 1, the system 120 can be implemented by one or more computers. As shown in stage (A) and stage (B) in FIG. 1, the system 120 receives a plurality of training examples 110, and processes the training examples 110 using a training engine 122 of the system to update model parameters 124 of a machine-learning model 121. Each training example can include a low-resolution distribution map 110a of an area, a reference map 110b of the same area, and a high-resolution distribution map 110c of the same area.

As shown in stage (C) in FIG. 1, the system 120 receives input data 121, processes the received data using the machine-learning model 121 with the learned model parameters 124 and outputs a high-resolution synthesized fire map 155 based on the processing results to an output device 150. The input data can include a low-resolution distribution map 140a of an area with fire burning and a reference map 140b of the same area.

In this specification, “low-resolution” and “high-resolution” describe spatial resolutions in a relative sense. For example, when the input distribution map 140a has a first spatial resolution R₁ (e. g., 400 m/pixel), and the output distribution map 155 has a third spatial resolution R₃ (e. g., 20 m/pixel), since the third spatial resolution R₃ is higher resolution than the first resolution R₁, the output distribution map 155 is deemed as a high-resolution map while the input distribution map 140a is deemed a low-resolution map.

In the example shown in FIG. 1, the input low-resolution distribution map 140a is a low-resolution infrared image. In general, the input low-resolution distribution map 140a can include a distribution map or dataset that indicates fire distribution of an area with fire burning. The low-resolution infrared image is an example of the distribution map.

Since active fire burning on the ground emits spectral signals that are characterized by increased emissions of mid-infrared radiation, which can be captured by satellite infrared sensors, a satellite infrared image can indicate a spatial distribution of active fire. The low-resolution infrared image 140a can be an infrared image in a single infrared band that corresponds to heat distribution, such as in a mid-IR band with central wavelengths of 2.1 μm, 4.0 μm, or 11.0 μm. The low-resolution infrared image 140a can also include additional infrared data in other infrared bands, such as in one or more near-IR bands with central wavelengths of 0.65 μm and/or 0.86 μm. These near-IR data can be used to calibrate artifacts such sun glint and cloud reflections. The low-resolution infrared image 140a can include multiple-channel infrared images taken at a plurality of infrared bands, or a composite infrared image that combines multiple-channel infrared images. In addition to the infrared images, the input low-resolution distribution map 140a can further include calibration and geolocation information, which can be used to pre-process the infrared images to ensure consistency between data sources and across different time points.

In certain implementations, instead of receiving infrared images directly from instrument measurements or simply combining multi-channel infrared images, the input low-resolution distribution map 140a of the input data can include derived products, such as a fire distribution map generated by processing multiple remote sensing images using fire-detection algorithms. A variety of fire products that map fire hotspots based on satellite remote-sensing images have been developed and are available from several organizations, and can be used as the input low-resolution distribution map 140a.

Whether being directly received remote-sensing measurements, or derived fire maps using fire-detection algorithms, a large quantity of maps indicating fire distribution can be retrieved from satellite remote-sensing image archives, or from satellite remote sensing image providers in near real-time. These maps can include a sequence of images taken at multiple time points for a same area, and thus can include information of the temporal features of fire spreading behavior. However, these maps often have poor spatial resolution, that is, each pixel in the map corresponds to a large area, and cannot provide spatially finer details of fire distribution.

The input reference map 140b, on the other hand, can provide higher-resolution features of the same area. In the example shown in FIG. 1, the input reference map 140b is a high-resolution aerial landscape image of the same area. In general, the input reference map 140b can include a reference map indicating certain features of the area. The reference map 140b has a spatial resolution higher than the spatial resolution of the input low-resolution distribution map 140a. For example, the input low-resolution distribution map 140a can have a spatial resolution around or below 400 m/pixel, while the reference map 140b can have a spatial resolution around or higher than 20 m/pixel.

In addition to having a different spatial resolution, the reference map 140b can be collected by sensors or imaging devices at a time point different from when the low-resolution distribution map 140a is collected. For example, the low-resolution distribution map 140a can be collected during an active fire, while the reference map 140b can be collected at a pre-fire time point or a post-fire time point, such as days, weeks, or months before or after the low-resolution distribution map 140a is collected. During active fire burning, a sequence of distribution maps 140a can be collected at multiple time points for the same area, thus providing information on the temporal spreading behavior of the fire. A reference map 140b can be used in conjunction with each of the sequence of distribution maps 140a to form the input data 140.

Further, the features indicated in the reference map 140b can be features other than fire or temperature-related distributions. That is, the reference map 140b can have a modality that is different from the modality of the low-resolution distribution map 140a. For example, the low-resolution distribution map 140a can be an infrared image or a fire distribution map derived from remote-sensing infrared data, while the reference map 140b can be an image in the visible wavelength range or a non-optical image. Examples of the reference map 140b include satellite images in the visible band (e. g., with central wavelength of 0.65 μm), aerial photos (e. g., collected by drones), labeled survey maps, and vegetation index maps calculated from visible and near-IR images. The reference maps 140b can provide information related to fire susceptibility, in higher resolutions compared to the distribution maps 140a, on features such as topographical features (e.g., altitudes, slopes, rivers, coastlines, etc.), man-made structures (roads, buildings, lots, etc.), vegetation indexes, and/or soil moistures of the same area. The reference map can also be a post-fire map that shows burn scar of the area, which also provide information that indicates fire susceptibility.

In some implementations, the reference map can have the same modality as the low-resolution distribution map but with higher resolution. For example, the low-resolution distribution map can be a fire distribution map collected during a recent fire incident while the reference map can be a fire map collected during a different fire incident, e.g., a past fire incident. When a high-resolution fire map collected in the past of the same area is available, the system can use the high-resolution past fire map to provide additional information for generating high-resolution map of a recent fire.

In certain implementations, the system 120 can further perform pre-processing of the input data. For example, the system 120 can use calibration data to calibrate the satellite infrared images and use the geolocation data to align and register the satellite infrared images with the reference map. The system can further convert a satellite infrared image set in the input data to a fire-distribution map based on a fire-detection algorithm. The fire-detection algorithm can include processes such as cloud masking, background characterization and removal, sun-glint rejection, and applying thresholds. The system 120 can then process the pre-processed input data, using a machine-learning model 121, to generate output data that includes a high-resolution synthesized distribution map 155.

The high-resolution synthesized distribution map 155 has a resolution higher than the resolution of the input distribution map 140a. For example, the input distribution map 140a can have a spatial resolution around or lower than 400 m/pixel, while the synthesized distribution map 155 can have a spatial resolution around or higher than 20 m/pixel.

In the example shown in FIG. 1, the high-resolution synthesized distribution map 155 is a fire-distribution map that shows, in higher spatial resolution, distribution of locations of fire burning. The fire-distribution map can be a binary map that has pixels with a high intensity value or a low intensity value. Pixels with the high intensity value in the map indicate active fire burning at the corresponding locations, while pixels with the low intensity value in the map indicate no active fire burning at the corresponding locations. Alternatively, the synthesized distribution map 155 can have multiple or a continuous distribution of pixel intensity values. Pixels with higher intensity values can indicate locations with increased probability of active fire burning. Alternatively, pixels with higher intensity values can indicate locations with higher intensities of fire burning, for example, different pixel intensity values can be mapped to different levels of fire radiative power (FRP).

In some implementations, the output fire distribution map 155 can include a sample fire distribution map derived from a probabilistic posterior distribution of possible fire distribution maps. The output 155 may also include a quantification of the GAN's uncertainty at each output pixel.

In general, the high-resolution synthesized distribution map 155 in the output data can be a map indicating fire distribution of the area. In some implementations, the output high-resolution synthesized distribution map 155 can have the same data type as the input low-resolution distribution map 140a, although they have different spatial resolutions. For example, the input distribution map 140a can be an infrared image with a first spatial resolution (e. g., ˜400 m/pixel) and the output distribution map 155 can also be an infrared image at the same band with a third spatial resolution (˜20 m/pixel) higher than the first spatial resolution. In some implementations, the output high-resolution synthesized distribution map 155 can have a different data type as the input low-resolution distribution map 140a, in addition to having a different spatial resolution. This configuration is shown in FIG. 1, where the input distribution map 140a is an infrared image with a first spatial resolution (e. g., ˜400 m/pixel) and the output distribution map 155 is a fire-distribution map with a third spatial resolution (e.g., ˜20 m/pixel) higher than the first spatial resolution.

The machine-learning model 121 can be a neural-network based model that processes the input data 140, including the low-resolution distribution map 140a and the reference map 140b, to generate the output data that includes a high-resolution synthesized distribution map 155. The machine-learning model 121 can be based on a generative adversarial neural network (GAN), which includes a generator neural network 121a to generate synthesized data and a discriminator neural network 121b to differentiate synthesized data from “real” data.

Although GANs have been employed for resolution-upscaling tasks in the past, those efforts were usually focused on designing a proper perceptual loss function in order to create a visually realistic image with increased resolution. By contrast, the machine-learning model 121 provided in this specification aims to leverage the additional information provided in the reference map 140b in generating high-resolution fire distribution maps. Unlike past super-resolution GAN models, the system 120 does not aim to provide images that are visually pleasing. This allows for a training process that is focused on learning the dynamics of fires. Specifically, as shown in stage (C) in FIG. 1, the machine-learning model 121 of the system 120 takes both the low-resolution distribution map 140a and the reference map 140b as input, and generates the output data including the high-resolution synthesized distribution map 155.

The machine-learning model 121 includes both the generator neural network 121a and the discriminator neural network 121b. The generator neural network 121a is used to process a neural-network input to generate the output data. The neural-network input to the generator neural network 121a can be a combination of the low-resolution distribution map 140a and the reference map 140b. For example, the input can be formed by stacking the low-resolution distribution map and the reference map.

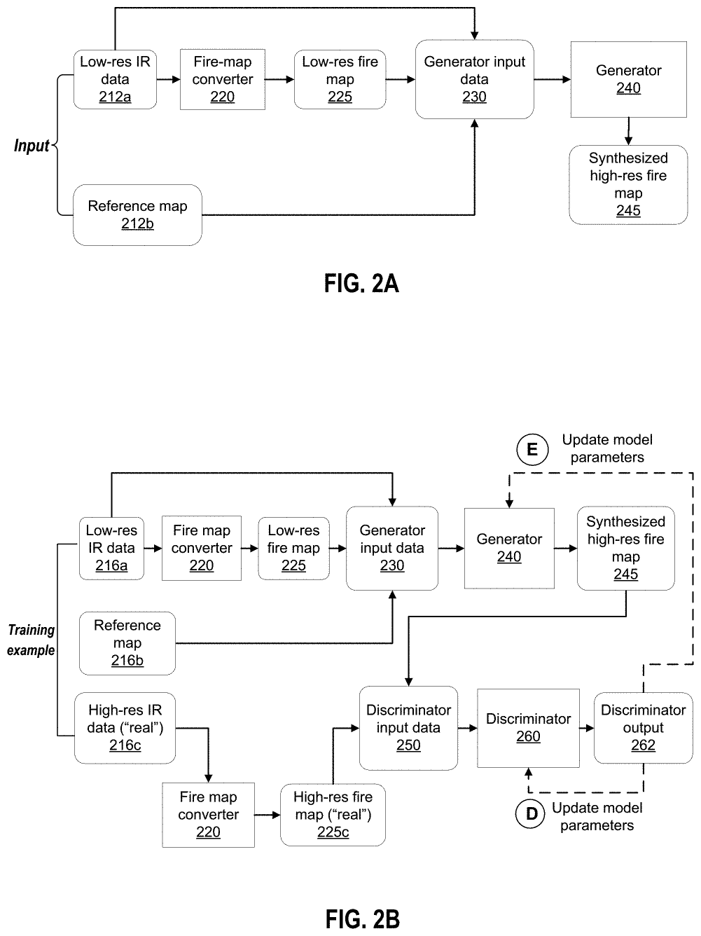

The generator neural network 121a can include a plurality of network layers, including, for example, one or more fully connected layers, convolution layers, parametric rectified linear unit (PReLU) layers, and/or batch normalization layers. In certain implementations, the generator neural network 121a can include one or more residual blocks that include skip connection layers. Additional details of using the generator neural network 121a to generate the output data will be described in FIG. 2A and the accompanying descriptions.

The generator neural network 121a includes a set of network parameters, including weight and bias parameters of the network layers. These parameters are updated in a training process to minimize a loss characterizing difference between the output of the model and a desired output. The set of network parameters of the generator neural network 121a are part of the model parameters 124 of the machine learning model 121. The system 120 further includes a training engine 122 to update these model parameters 124.

In the GAN configuration, the generator neural network 121a is trained together with the discriminator neural network 121b based on a plurality of training examples, as shown in stage (B) of FIG. 1. The discriminator neural network 121b can include a plurality of network layers, including, for example, one or more convolution layers, leaky rectified linear unit (ReLU) layers, dense layers, and/or batch normalization layers. The network parameters of the discriminator neural network 121b are also included in the model parameters 124, and are updated together with the network parameters of the generator neural network 121a in a repeated and alternating fashion during the train process. The discriminator neural network 121b outputs a prediction of whether an input to the discriminator neural network 121b is a real distribution map or a synthesized distribution map.

The training data used for updating the model parameters 122 includes a plurality of training examples 110. Each training example includes a set of three distribution maps, including a low-resolution distribution map 110a indicating fire distribution of an area, a reference map 110b indicating features of the same area, and a high-resolution distribution map 110c as “real” label data. In the example shown in FIG. 1, the low-resolution distribution map 110a is an infrared image, the reference map 110b is an aerial landscape image, and the high-resolution distribution map 110c is a fire distribution map. In general, similar to the discussion on the data types in the input data 140 and output map 155, the low-resolution distribution map 110a, the reference map 110b, and the high-resolution distribution map 110c can be other types of images indicating fire distribution or land features. For example, the low-resolution distribution map 110a can be a derived fire-distribution map, the high-resolution distribution map 110c can be a high-resolution infrared map, and the reference map 110b can be a vegetation index map.

As shown in stage (A) of FIG. 1, the plurality of training examples are collected and used by the training engine 122 for updating the model parameters 124. In each training example, the low-resolution distribution map 110a, the reference map 110b, and the high-resolution distribution map 110c correspond to the same geographical area. Further, in each training example, the low-resolution distribution map 110a and the high-resolution distribution map 110c correspond to the same time point.

In some instances, both high-resolution and low-resolution satellite measurements are available for the same area at the same time point during an active fire. These measurements can be collected as the high-resolution distribution map 110c and the low-resolution distribution map 110a, respectively. In some other instances, when only the high-resolution satellite measurements are available for an area under active fire burning, the low-resolution distribution map 110a can be generated by down-sampling the corresponding high-resolution distribution map 110c in order to create additional training examples.

In some implementations, further re-sampling can be performed to ensure that the low-resolution distribution maps 10a in the training examples have a same spatial resolution as the low-resolution distribution map 140a in the input data, the reference maps 110b in the training examples have a same spatial resolution with the reference map 140b in the input data, and the high-resolution distribution maps 110c in the training examples have a same spatial resolution as the high-resolution synthesized distribution map 155 in the output data.

During training, the training engine 122 updates the model parameters 124 of the generator neural network 121a and the discriminator neural network 121b based on the plurality of training samples 110. In some implementations, the training engine 122 can update the model parameters 124 by repeatedly performing two alternating steps. In the first step, the training engine 122 updates a first set of weighting and bias parameters of the discriminator neural network 121b based on a comparison of the outputted prediction of the discriminator and whether the input to the discriminator neural network is the high-resolution distribution map 110c in one of the training examples 110, or a high-resolution synthesized distribution map 155 outputted by the generator neural network. In the second step, the training engine 122 updates a second set of weighting and bias parameters of the generator neural network 121a based on the outputted prediction of the discriminator neural network while the input to the discriminator neural network is the synthesized distribution map outputted by the generator neural network. The details of the training process will be further presented in FIG. 2B and the accompanying descriptions.

To summarize the overall operation of the high-resolution fire-map generating system 120 in the example shown in FIG. 1: in stage (A), a plurality of training examples 110 are collected; in stage (B), a training engine 122 updates model parameters 124 of a machine learning model 121 including a generator neural network 121a and a discriminator neural network 121b based on the training examples 110; and in stage (C), the system uses the machine learning model 121 with the updated model parameters 124 to process the input data 140, including the low-resolution distribution map 140a and the reference map 140b, to generate output data including the high-resolution synthesized distribution map 155.

FIG. 2A shows an example of an inference process of the system 120 to generate the high-resolution synthesized distribution map in the output data from input data including a low-resolution distribution map indicating fire distribution of an area. In the specific example shown in FIG. 2A, the low-resolution distribution map in the input data is a low-resolution infrared dataset 212a collected for an area with active fire burning. The reference map 212b indicates features of the same area, and can be an aerial landscape image collected for the same area collected at a pre-fire time point or at a post-fire time point. The reference map 212b has a spatial resolution higher than the spatial resolution of the low-resolution infrared data 212a.

The system first uses a fire-map converter 220 to convert the input low-resolution infrared data 212a to a low-resolution fire distribution map 225. The fire-map converter 220 can perform a series of processes such as cloud masking, background characterization and removal, sun-glint rejection, and applying thresholds. The low-resolution fire distribution map 225 can be a binary map that has pixels with a high intensity value or a low intensity value. Pixels with the high intensity value in the map 225 indicate active fire burning at the corresponding locations, while pixels with the low intensity value in the map indicate no active fire burning at the corresponding locations. Alternatively, the low-resolution fire distribution map 225 can have multiple or a continuous distribution of pixel intensity values. Pixels with higher intensity values can indicate locations with increased probability of active fire burning. Alternatively, pixels with higher intensity values can indicate locations with higher intensities of fire burning, for example, different pixel intensity values can be mapped to different levels of fire radiative power (FRP).

Next, the system combines the low-resolution fire distribution map 225 and the input reference map 212b to form the generator input data 230 to the generator neural network 240. For example, the system can stack the low-resolution fire distribution map 225 and the input reference map 212b to form the input data 230.

Next, the system uses a pre-trained generator neural network 240 to process the input data 230 to generate the output data including high-resolution synthesized fire map 245. The generator neural network 240 is a neural network that can include a plurality of neural network layers, including, for example, one or more fully connected layers, convolution layers, parametric rectified linear unit (PRelU) layers, and batch normalization layers. In certain implementations, the generator neural network 240 can include one or more residual blocks that include skip connection layers. The generator neural network receives the input data 230, applies neural-network processing to the input data 230 through each of the plurality of neural network layers, and outputs output data that includes the high-resolution synthesized fire map 245.

FIG. 2B illustrates the training process of the system to learn model parameters of the generator neural network 240 and the discriminator neural network 260 based on a plurality of training examples. In the specific example shown in FIG. 2B, each training example includes low-resolution infrared data 216a of an area with active fire burning, a reference map 216b of the same area with a higher spatial resolution, and high-resolution infrared data 216c of the same area. The training engine uses the high-resolution infrared data 216c as “real” data labels.

Similar to the process shown in FIG. 2A, system first uses the fire-map converter 220 to convert the low-resolution infrared data 216a in each training example to a low-resolution fire distribution map 225. The system further uses the fire-map converter 220 to convert the high-resolution infrared data 216c in each training example to a high-resolution fire distribution map 225c to be consistent with the model output.

Next, the system combines the low-resolution fire distribution map 225 and the reference map 216b in the training example to form the generator input data 230 to the generator neural network 240. The system then uses the generator neural network 240 to process the input data 230 to generate the output data including high-resolution synthesized fire map 245.

During training of the discriminator neural network 260, the system uses both the high-resolution synthesized fire distribution map 245 outputted from the generator neural network 240 and the high-resolution fire distribution map 225c derived from the high-resolution infrared label data in the training example as the input data 250 to the discriminator neural network 260. The goal of the discriminator neural network 260 is to distinguish between the synthesized map 245 and the high-resolution fire distribution map 225c (the “real” map). The discriminator neural network 260 processes the synthesized map 245 and the “real” map 225c to generate a discriminator output 262. The discriminator output 262 can include predictions of whether the input map is a synthesized map or a “real” map. More specifically, the discriminator output 262 can include a probability score measuring the likelihood of an input map being a real map.

Next, the system can compare the predictions in the discriminator output 262 using a loss function with the correct labels whether the map in the discriminator input data 250 is synthesized or “real” (e.g., a score of “1” when the input map is “real” and a score of “0” when the input map is a synthesized map). The goal of the discriminator 260 is to minimize a comparison loss between the predictions in the discriminator output with the correct labels. As shown in stage (D) in FIG. 2B, the system updates the model parameters of the discriminator neural network 260 based on the comparison result to using techniques such as gradient backpropagation.

After the model parameters of the discriminator neural network 260 are updated, the system can use the updated discriminator neural network 260 to generate the discriminator output 262 again based on a synthesized map 245 as the discriminator input 250. Then the system can use the discriminator output 262 to update the model parameters of the generator neural network 240. The goal of the generator neural network 240 is to generate synthesized map that is as close to the “real” map as possible in a feature space, that is, to minimize a comparison loss between the predicted probability score in the discriminator output 262 with the desired probability score, e.g., a score of “1” representing the input image being “real”. As shown in stage (E) of FIG. 2B, the system can update the model parameters of the generator neural network 240 based on the comparison result using techniques such as gradient backpropagation.

The processes for updating the model parameters of the generator neural network 240 (stage (D)) and for updating the model parameters of the discriminator neural network 260 (stage (E)) can be repeated in an alternating manner, until a stop criterion is reached, e. g., when a difference between the synthesized maps 245 and the “real” map 225c is below a threshold. The model parameters of the generator neural network 240 and the model parameters of the discriminator neural network 260 both improve over time during the repeated alternating training process.

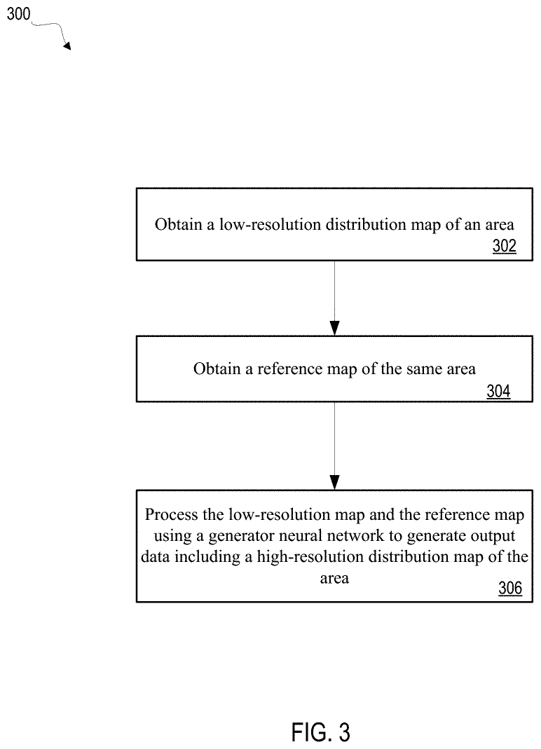

FIG. 3 is a flow chart illustrating a method 300 for generating high-resolution maps indicating fire distributions. The method can be implemented by a computer system, such as the system 120 in FIG. 1. As shown in FIG. 3, the method 300 includes the following steps.

Step 302 is to obtain a low-resolution distribution map. The low-resolution distribution map has a first spatial resolution and contains information indicating fire distribution of an area with fire burning. In an example, the first spatial resolution can be a resolution around or no higher than 400 m/pixel. An example of the data type of the low-resolution distribution map includes low-resolution satellite infrared images in one or more bands. Another example of the low-resolution distribution map includes a fire distribution map derived from satellite infrared measurements. In some implementations, the method further includes converting a low-resolution satellite infrared image to a low-resolution fire distribution map indicating a spatial distribution of probabilities of active fire burning or a spatial distribution of fire radiative power.

Step 303 is to obtain a reference map of the same area. The reference map has a second spatial resolution and contains information indicating features of the area. The second spatial resolution is higher than the first spatial resolution. For example, the second spatial resolution can be a resolution higher than 10 m/pixel. The reference map can be collected by sensors or imaging devices at a time point different from when the low-resolution distribution map is collected. For example, the low-resolution distribution map can be collected during an active fire, while the reference map can be collected at a pre-fire or post-fire time point, such as days, weeks, or months before or after the low-resolution distribution map is collected.

The reference map can have a modality that is different from the modality of the low-resolution distribution map. For example, the low-resolution distribution map can be an infrared image or a fire distribution map derived from remote-sensing infrared data, while the reference map can be an image in the visible wavelength range or a non-optical image. Examples of the reference map include satellite images in the visible band, aerial photos (e. g., collected by drones), labeled survey maps, and vegetation index maps calculated from visible and near-IR images. The reference map can be a pre-fire map that provides information related to fire susceptibility, in higher resolutions compared to the low-resolution distribution map, on features such as topographical features (e.g., altitudes, slopes, rivers, coastlines, etc.), man-made structures (roads, buildings, lots, etc.), vegetation indexes, and/or soil moistures of the same area. The reference map can also be a post-fire map that shows burn scar of the area, which also provide information that indicates fire susceptibility.

Step 306 is to process the low-resolution map and the high-resolution reference map using a generator neural network to generate output data including a high-resolution synthesized distribution map of the area. The high-resolution synthesized distribution map in the output data has the third spatial resolution that is higher than the first spatial resolution. For example, the third spatial resolution can be a resolution higher than 20 m/pixel, and provides spatial fire distribution on a finer scale.

In some implementations, the high-resolution synthesized distribution map can have the same data type as the low-resolution distribution map. For example, both can be infrared images, albeit having different spatial resolutions. In some other implementations, the high-resolution synthesized distribution map can have a data type different from low-resolution distribution map. For example, the low-resolution distribution map can be a satellite infrared image while the high-resolution synthesized distribution map can be a map of fire radiative power distribution.

The generator neural network used to generate the high-resolution synthesized distribution map is trained with a discriminator neural network. The discriminator neural network outputs a prediction of whether an input to the discriminator neural network is a real distribution map or a synthesized distribution map.

In some implementations, the method 300 further includes performing training of the generator neural network and the discriminator neural network to update their parameters based on a plurality of training examples. Each training example includes a low-resolution training distribution map having the first spatial resolution, a reference training map having the second spatial resolution, and a high-resolution training distribution map having the third spatial resolution. The training process includes repeatedly performing two alternating steps. The first step is to update a first set of weighting and bias parameters of the discriminator neural network based on a comparison of the outputted prediction of the discriminator and whether the input to the discriminator neural network is the high-resolution training distribution map in one of the training examples or the high-resolution synthesized distribution map outputted by the generator neural network. The second step is to update a second set of weighting and bias parameters of the generator neural network based on the outputted prediction of the discriminator neural network while the input to the discriminator neural network is the high-resolution synthesized distribution map outputted by the generator neural network. The training of the generator can further include a content loss of the generator, which optionally includes a perceptual loss.

The two updating steps in the training process can be alternatingly and repeatedly performed to improve the parameters of the generator neural network and the parameters of the discriminator neural network, until a stop criterion is reached, for example, when the differences between the high-resolution synthesized maps and the “real” high-resolution maps are below a threshold. After training, the generator neural network with the updated parameters then can be used to generate the output data including the high-resolution synthesized distribution map.

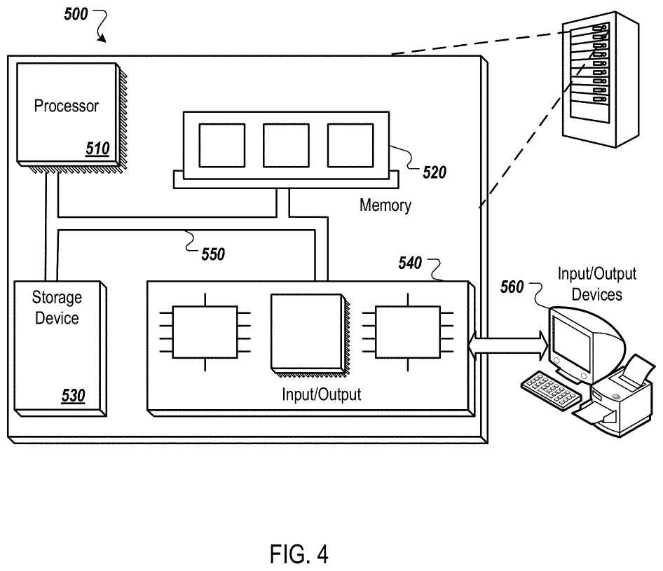

FIG. 4 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (for example, a cloud storage device), or some other large capacity storage device.

The input/output device 540 provides input/output operations for the system 500. In one implementation, the input/output device 540 can include one or more network interface devices, for example, an Ethernet card, a serial communication device, for example, a RS-232 port, and/or a wireless interface device, for example, a 502.11 card. In another implementation, the input/output device can include driver devices configured to receive input data and send output data to other input/output devices, for example, keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by a data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, that is, one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, for example, an FPGA (field programmable gate array) or an ASIC (application-specific integrated circuit). The apparatus can optionally include, in addition to hardware, code that creates an execution environment for computer programs, for example, code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, for example, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device, for example, a universal serial bus (USB) flash drive, to name just a few.

Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of messages to a personal device, for example, a smartphone that is running a messaging application and receiving responsive messages from the user in return.

Data processing apparatus for implementing machine learning models can also include, for example, special-purpose hardware accelerator units for processing common and compute-intensive parts of machine learning training or production, that is, inference, workloads.

Machine learning models can be implemented and deployed using a machine learning framework, for example, a TensorFlow framework, a Microsoft Cognitive Toolkit framework, an Apache Singa framework, or an Apache MXNet framework.

Embodiments of the subject matter described in this specification can be implemented in a computing system that includes a back-end component, for example, as a data server, or that includes a middleware component, for example, an application server, or that includes a front-end component, for example, a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, for example, an HTML page, to a user device, for example, for purposes of displaying data to and receiving user input from a user interacting with the device, which acts as a client. Data generated at the user device, for example, a result of the user interaction, can be received at the server from the device.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claim is:

1. A computer-implemented method, comprising:
obtaining a low-resolution distribution map indicating fire distribution of an area with fire burning, the low-resolution distribution map having a first spatial resolution;
obtaining a reference map indicating features of the area, the reference map having a second spatial resolution higher than the first spatial resolution;
processing the low-resolution distribution map and the reference map using a generator neural network that is trained, based on a plurality of training examples, with a discriminator neural network that outputs a prediction of whether an input to the discriminator neural network is a real distribution map or a synthesized distribution map, to generate output data including a high-resolution synthesized distribution map indicating fire distribution of the area, the high-resolution synthesized distribution map having a third spatial resolution higher than the first spatial resolution; and
outputting the high-resolution synthesized distribution map to a device.

2. The method according to claim 1, wherein:
each of the training examples includes a low-resolution training distribution map having the first spatial resolution, a reference training map having the second spatial resolution, and a high-resolution training distribution map having the third spatial resolution; and
the method further comprises:
updating a first set of weighting and bias parameters of the discriminator neural network based on a comparison of the outputted prediction of the discriminator and whether the input to the discriminator neural network is the high-resolution training distribution map in one of the training examples or the high-resolution synthesized distribution map outputted by the generator neural network; and
updating a second set of weighting and bias parameters of the generator neural network based on the outputted prediction of the discriminator neural network while the input to the discriminator neural network is the high-resolution synthesized distribution map outputted by the generator neural network.

3. The method according to claim 2, further comprising:
for each of one or more of the plurality of training examples, generating the low-resolution training distribution map from the high-resolution training distribution map by down-sampling the high-resolution training distribution map from the third spatial resolution to the first spatial resolution.

4. The method according to claim 1, wherein processing the high-resolution distribution map and the reference map using the generator neural network includes:
generating an input to the generator neural network by combining the low-resolution distribution map and the reference map.

5. The method according to claim 1, wherein:
the low-resolution distribution map includes a low-resolution satellite infrared image of the area with active fire burning.

6. The method according to claim 5, further comprising:
converting the low-resolution satellite infrared image to a low-resolution fire distribution map indicating a spatial distribution of probabilities of active fire burning.

7. The method according to claim 6, wherein converting the low-resolution satellite infrared image to the low-resolution fire distribution map includes one or more of:
cloud masking;
background characterization and removal;
sun-glint rejection; or
applying one or more thresholds.

8. The method according to claim 1, wherein:
the high-resolution synthesized distribution map includes a high-resolution fire distribution map indicating a spatial distribution of probabilities of active fire burning.

9. The method according to claim 1, wherein:
the high-resolution synthesized distribution map includes a high-resolution fire distribution map indicating a spatial distribution of fire radiative power.

10. The method according to claim 1, wherein:
the reference map is associated with a different image modality from the low-resolution distribution map.

11. The method according to claim 10, wherein:
the reference map includes an image collected at a pre-fire time point.

12. The method according to claim 11, wherein the reference map includes one or more of:
a distribution of ground topographical features;
a distribution of manmade structures;
a distribution of vegetation index; or
a distribution of soil moistures.

13. The method according to claim 1, wherein:
the low-resolution distribution map is collected during a first time point of a fire incident; and
the reference map is collected during a second time point different from the first time point of the fire incident.

14. The method according to claim 1, wherein:
the first spatial resolution is a resolution no higher than 400 m/pixel.

15. The method according to claim 1, wherein:
the third spatial resolution is a resolution no lower than 20 m/pixel.

16. A system comprising:
one or more computers; and
one or more storage devices storing instructions that when executed by the one or more computers, cause the one or more computers to perform:
obtaining a low-resolution distribution map indicating fire distribution of an area with fire burning, the low-resolution distribution map having a first spatial resolution;
obtaining a reference map indicating features of the area, the reference map having a second spatial resolution higher than the first spatial resolution;
processing the low-resolution distribution map and the reference map using a generator neural network that is trained, based on a plurality of training examples, with a discriminator neural network that outputs a prediction of whether an input to the discriminator neural network is a real distribution map or a synthesized distribution map, to generate output data including a high-resolution synthesized distribution map indicating fire distribution of the area, the high-resolution synthesized distribution map having a third spatial resolution higher than the first spatial resolution; and
outputting the high-resolution synthesized distribution map to a device.

17. The system of claim 16, wherein:
each of the training examples includes a low-resolution training distribution map having the first spatial resolution, a reference training map having the second spatial resolution, and a high-resolution training distribution map having the third spatial resolution; and
the instructions stored in the one or more storage devices, when executed by the one or more computers, cause the one or more computers to further perform:
updating a first set of weighting and bias parameters of the discriminator neural network based on a comparison of the outputted prediction of the discriminator and whether the input to the discriminator neural network is the high-resolution training distribution map in one of the training examples or the high-resolution synthesized distribution map outputted by the generator neural network; and
updating a second set of weighting and bias parameters of the generator neural network based on the outputted prediction of the discriminator neural network while the input to the discriminator neural network is the high-resolution synthesized distribution map outputted by the generator neural network.

18. The system of claim 17, wherein the instructions stored in the one or more storage devices, when executed by the one or more computers, cause the one or more computers to further perform:
for each of one or more of the plurality of training examples, generating the low-resolution training distribution map from the high-resolution training distribution map by down-sampling the high-resolution training distribution map from the third spatial resolution to the first spatial resolution.

19. One or more computer-readable storage media storing instructions that, when executed by one or more computers, cause the one or more computers to perform:
obtaining a low-resolution distribution map indicating fire distribution of an area with fire burning, the low-resolution distribution map having a first spatial resolution;
obtaining a reference map indicating features of the area, the reference map having a second spatial resolution higher than the first spatial resolution;
processing the low-resolution distribution map and the reference map using a generator neural network that is trained, based on a plurality of training examples, with a discriminator neural network that outputs a prediction of whether an input to the discriminator neural network is a real distribution map or a synthesized distribution map, to generate output data including a high-resolution synthesized distribution map indicating fire distribution of the area, the high-resolution synthesized distribution map having a third spatial resolution higher than the first spatial resolution; and
outputting the high-resolution synthesized distribution map to a device.

20. The one or more computer-readable storage media of claim 19, wherein:
each of the training examples includes a low-resolution training distribution map having the first spatial resolution, a reference training map having the second spatial resolution, and a high-resolution training distribution map having the third spatial resolution; and
the instructions stored in the one or more computer-readable storage media, when executed by the one or more computers, cause the one or more computers to further perform:
updating a first set of weighting and bias parameters of the discriminator neural network based on a comparison of the outputted prediction of the discriminator and whether the input to the discriminator neural network is the high-resolution training distribution map in one of the training examples or the high-resolution synthesized distribution map outputted by the generator neural network; and
updating a second set of weighting and bias parameters of the generator neural network based on the outputted prediction of the discriminator neural network while the input to the discriminator neural network is the high-resolution synthesized distribution map outputted by the generator neural network.
